(19) United States
(12) Patent Application Publication
(10) Pub. No.: US 2025/0344018 A1
(43) Pub. Date: Nov. 6, 2025

(54) LOUDSPEAKER DEVICE

(71) Applicant: Panasonic Intellectual Property Management Co., Ltd., Osaka (JP)

(72) Inventors: Shuji SAIKI, Nara (JP); Mariko YAMADA, Hyogo (JP); Tomokazu ISHIKAWA, Osaka (JP); Atsushi SAKAGUCHI, Kyoto (JP)

(21) Appl. No.: 19/267,971

(22) Filed: Jul. 14, 2025

Related U.S. Application Data
(63) Continuation of application No. PCT/JP2024/000729, filed on Jan. 15, 2024.
(60) Provisional application No. 63/440,495, filed on Jan. 23, 2023.

(30) Foreign Application Priority Data
Oct. 13, 2023 (JP) 2023-177350

(51) Int. Cl. H04R 1/34; H04R 1/02; H04R 1/28; H04R 1/30

(52) U.S. Cl. CPC H04R 1/347; H04R 1/025; H04R 1/288; H04R 1/30

(57) ABSTRACT

A loudspeaker device includes: a loudspeaker unit; and a casing that is tubular and defines an internal space in which the loudspeaker unit is housed. The casing includes: a tubular component that includes, at one end, an opening to which the loudspeaker unit is attached and, at an other end, an other opening; and a base panel that covers the other opening of the tubular component. The tubular component further includes a plurality of through holes that connect the internal space and an external space that is outside of the casing, and the plurality of through holes are located at different positions in a central axis direction of the tubular component.

### CROSS REFERENCE TO RELATED APPLICATIONS

This is a continuation application of PCT International Application No. PCT/JP2024/000729 filed on Jan. 15, 2024, designating the United States of America, which is based on and claims priority of U.S. Provisional Patent Application No. 63/440,495 filed on Jan. 23, 2023 and Japanese Patent Application No. 2023-177350 filed on Oct. 13, 2023. The entire disclosures of the above-identified applications, including the specifications, drawings and claims are incorporated herein by reference in their entirety.

### FIELD

The present disclosure relates to a loudspeaker device.

### BACKGROUND

Patent Literature (PTL) 1 discloses a narrow directivity loudspeaker in which an acoustic tube that includes a plurality of acoustic holes arranged in a length direction is attached to a loudspeaker unit. This narrow directivity loudspeaker realizes narrow directivity by using phase difference between sounds emitted from the loudspeaker unit through the plurality of acoustic holes.

### CITATION LIST

### Patent Literature

PTL1: Japanese Unexamined Patent Application Publication No. H11-234784

### SUMMARY

### Technical Problem

However, in the technique disclosed in PTL 1, the acoustic tube needs to be long for causing phase difference between sounds that are in a low frequency range and each have a long wavelength, and therefore the loudspeaker device becomes big.

The present disclosure provides a loudspeaker device having narrow directivity for a sound in a low frequency range while suppressing increase in size of the loudspeaker device.

### Solution to Problem

A loudspeaker device according to an aspect of the present disclosure includes: a loudspeaker unit; and a casing that defines an internal space in which the loudspeaker unit is housed. The casing includes: a fixing component that fixes the loudspeaker unit in an orientation that exposes a diaphragm of the loudspeaker unit; a tubular component that includes, at one end, an opening to which the fixing component is provided and, at an other end, an other opening; and a base panel that covers the other opening of the tubular component, and the tubular component further includes a plurality of through holes that connect the internal space and an external space that is outside of the casing, the plurality of through holes being located at different positions in a central axis direction of the tubular component.

### Advantageous Effects

According to an aspect of the present disclosure, a loudspeaker device having narrow directivity for a sound in a low frequency range can be realized while suppressing increase in size of the loudspeaker device.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a perspective view illustrating an example of the external appearance of a loudspeaker device according to Embodiment 1.

FIG. 2A is a diagram for describing sounds reproduced in a loudspeaker device according to a comparative example.

FIG. 2B is a diagram for describing sounds reproduced in the loudspeaker device according to Embodiment 1.

FIG. 3 is a diagram for describing each direction with respect to the loudspeaker device.

FIG. 4A is a graph illustrating the directivity characteristics of sound pressure of the loudspeaker device according to Embodiment 1.

FIG. 4B is a graph illustrating the directivity characteristics of sound pressure of a loudspeaker device according to a conventional example.

FIG. 5 is a perspective view illustrating an example of the external appearance of a loudspeaker device according to Embodiment 2.

FIG. 6 is a cross-sectional perspective view illustrating an example of the loudspeaker device according to Embodiment 2.

FIG. 7 is a perspective view illustrating an example of the external appearance of an acoustic lens according to Embodiment 2.

FIG. 8 is a cross-sectional view of the acoustic lens according to Embodiment 2.

FIG. 9 is a diagram for describing an effect of the acoustic lens according to Embodiment 2.

FIG. 10A is a graph illustrating the directivity characteristics of sound pressure of a loudspeaker device according to a conventional example.

FIG. 10B is a graph illustrating the directivity characteristics of sound pressure of a loudspeaker device according to a comparative example.

FIG. 10C is a graph illustrating the directivity characteristics of sound pressure of the loudspeaker device according to Embodiment 2.

FIG. 11 is a perspective view illustrating an example of the external appearance of a loudspeaker device according to Embodiment 3.

FIG. 12 is a graph illustrating the directivity characteristics of sound pressure of the loudspeaker device according to Embodiment 3.

### DESCRIPTION OF EMBODIMENTS

A loudspeaker device according to a first aspect of the present disclosure includes: a loudspeaker unit; and a casing that defines an internal space in which the loudspeaker unit is housed. The casing includes: a fixing component that fixes the loudspeaker unit in an orientation that exposes a diaphragm of the loudspeaker unit; a tubular component that includes, at one end, an opening to which the fixing component is provided and, at an other end, an other opening; and a base panel that covers the other opening of the tubular component, and the tubular component further includes a plurality of through holes that connect the internal space and an external space that is outside of the casing, the plurality of through holes being located at different positions in a central axis direction of the tubular component.

Accordingly, since one or more through holes that connect the internal space and the external space of the casing are provided to the tubular component of the casing in which the loudspeaker unit is housed, among sounds reproduced by the loudspeaker unit, a sound that travels around the loudspeaker device can be canceled out by a sound that is emitted from at least one of the one or more through holes and has an inverted phase relative to the sound that travels around the loudspeaker device. For example, a sound that is in a low frequency range and is likely to travel around the loudspeaker device can be canceled out. In other words, a sound emitted from the loudspeaker unit can be controlled to have directivity in the front direction. Moreover, since a sound that travels around the loudspeaker device is canceled out by using a sound having an inverted phase relative to the sound that travels around the loudspeaker, the casing does not need to be long for the purpose of achieving narrow directivity. Thus, according to an aspect of the present disclosure, the loudspeaker device having narrow directivity for a sound in the low frequency range can be realized while suppressing increase in size of the loudspeaker device. For example, such a loudspeaker device can reduce the possibility of a sound that travels around the loudspeaker device being heard by a person who is present in the vicinity of the loudspeaker device.

Moreover, for example, a loudspeaker device according to a second aspect of the present disclosure is the loudspeaker device according to the first aspect, and the plurality of through holes may be arranged in the central axis direction.

Accordingly, the loudspeaker device can cancel out a sound that is in the low frequency range and travels around the loudspeaker device, by a sound that is emitted from at least one of the plurality of through holes arranged in a column and has an inverted phase relative to the sound that travels around the loudspeaker device.

Moreover, for example, a loudspeaker device according to a third aspect of the present disclosure is the loudspeaker device according to the second aspect, and a plurality of columns that are each a column of the plurality of through holes arranged in the central axis direction may be arranged in a circumferential direction of the tubular component.

Accordingly, since a sound that travels around the loudspeaker device in the circumferential direction can be canceled out, the loudspeaker device having very narrow directivity particularly for a sound in the low frequency range can be realized.

Moreover, for example, a loudspeaker device according to a fourth aspect of the present disclosure is the loudspeaker device according to any one of the first to third aspects, and may further include a sound absorbing component that is disposed in the internal space.

Accordingly, a standing wave is generated in the internal space, and the quality of an emitted sound can be prevented from changing (deteriorating).

Moreover, for example, a loudspeaker device according to a fifth aspect of the present disclosure is the loudspeaker device according to any one of the first to fourth aspects, and may further include an acoustic lens that is disposed at a position that is outside of the diaphragm of the loudspeaker unit and at which the acoustic lens covers the diaphragm.

Accordingly, by the acoustic lens, a sound in a high frequency range can be controlled to have directivity in the front direction. Therefore, not only the directivity of a sound in the low frequency range but also the directivity of a sound in the high frequency range can be controlled.

Moreover, for example, a loudspeaker device according to a sixth aspect of the present disclosure is the loudspeaker device according to the fifth aspect, and the acoustic lens may include: a first route that is located at a position that coincides with a central axis of the loudspeaker unit; and a second route that is located in a vicinity of the first route and is shorter than the first route.

Accordingly, a sound in the high frequency range can be controlled to have directivity in the front direction.

Moreover, for example, a loudspeaker device according to a seventh aspect of the present disclosure is the loudspeaker device according to any one of the first to sixth aspects, and may further include a horn that is disposed outside of the diaphragm of the loudspeaker unit and emits a sound outputted from the loudspeaker unit.

Accordingly, by the horn, a sound from the loudspeaker unit can be controlled to have directivity in the front direction. Therefore, the directivity of a sound from the loudspeaker unit can be controlled.

Hereinafter, a loudspeaker device according to an aspect of the present disclosure will be specifically described with reference to the Drawings.

Hereinafter, embodiments will be specifically described with reference to the Drawings.

It should be noted that each of the embodiments described below shows a general or specific example. The numerical values, shapes, constituent elements, the arrangement and connection of the constituent elements, etc. shown in the following embodiments are mere examples, and therefore do not limit the scope of the present disclosure. Moreover, among the constituent elements in the following embodiments, a constituent element not recited in the independent claim is described as an arbitrary constituent element.

Furthermore, the respective figures are schematic diagrams and are not necessarily precise illustrations. Accordingly, for example, the scaling, etc., depicted in the drawings is not necessarily accurate. Moreover, in the respective figures, elements that are substantially the same share the same reference signs and overlapping description thereof may be omitted or simplified.

Furthermore, in the present Specification and Drawings, the X-axis, Y-axis, and Z-axis indicate the three axes of a right-handed three-dimensional orthogonal coordinate system. In the embodiments, the Z-axis direction is a front-back direction of the loudspeaker unit. Moreover, in the present Specification, “a plan view” means a view in which the loudspeaker device is viewed in the front-back direction of the loudspeaker unit.

Moreover, in the present Specification, a term indicating relations between elements, such as ‘parallel’; a term indicating the shape of an element, such as ‘cylindrical’; a numerical value; and a numerical range are not precise expressions and include the substantially same range or a margin of error of a few percent (or approx. 10%), for example.

Moreover, in the present Specification, ordinal numbers, such as “first” and “second”, do not mean the number or order of constituent elements unless otherwise specified, and are used for the purpose of avoiding confusion of constituent elements of the same type and differentiating them.

### Embodiment 1

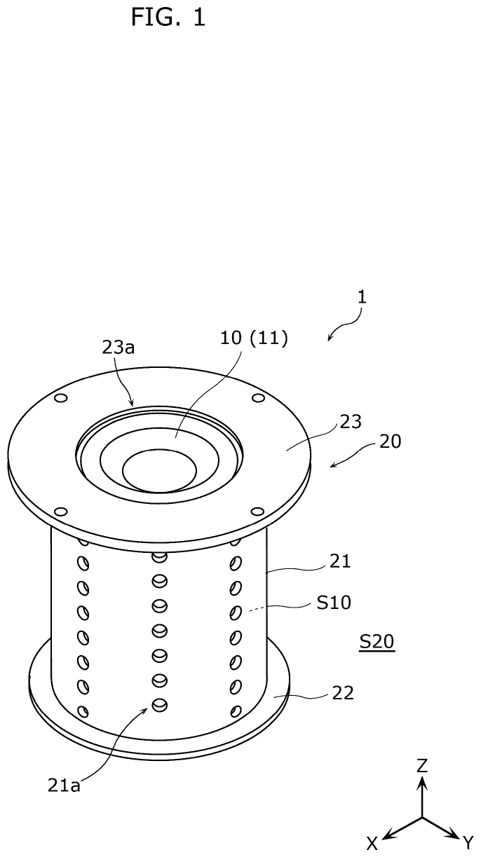

Hereinafter, a loudspeaker device according to the present embodiment will be described with reference to FIG. 1 to FIG. 4B.

### (1-1. Configuration of Loudspeaker Device)

First, a configuration of the loudspeaker device according to the present embodiment will be described with reference to FIG. 1. FIG. 1 is a perspective view illustrating an example of the external appearance of loudspeaker device 1 according to the present embodiment.

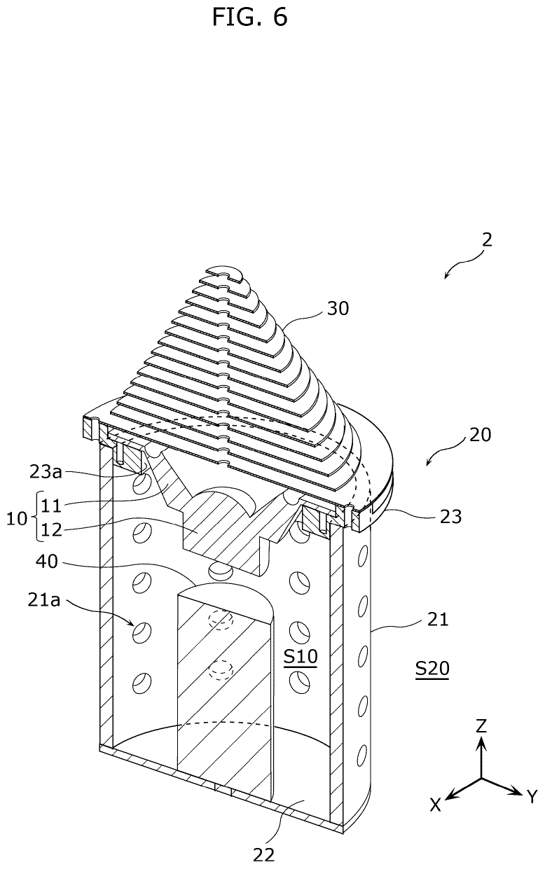

As illustrated in FIG. 1, loudspeaker device 1 includes loudspeaker unit 10 and casing 20. Loudspeaker device 1 may further include a sound absorbing component (e.g., sound absorbing component 40 described later and shown in FIG. 6) in casing 20. Sound absorbing component 40 will be described in Embodiment 2.

It should be noted that in the present disclosure, the front side of loudspeaker device 1 is a side on which diaphragm 11 of loudspeaker unit 10 included in loudspeaker device 1 is disposed, and the back side of loudspeaker device 1 is a side on which magnetic circuit 12 (see FIG. 6) included in loudspeaker unit 10 is disposed. In other words, the front side of loudspeaker device 1 indicates a direction from magnetic circuit 12 toward diaphragm 11 (Z-axis positive direction), magnetic circuit 12 and diaphragm 11 being included in loudspeaker device 1, and the back side of loudspeaker device 1 indicates a direction from diaphragm 11 toward magnetic circuit 12 (Z-axis negative direction).

Loudspeaker unit 10 is attached to baffle board 23 of casing 20. Loudspeaker unit 10 is configured to include diaphragm 11, magnetic circuit 12 (see FIG. 6), and a voice coil (not illustrated in the Drawings).

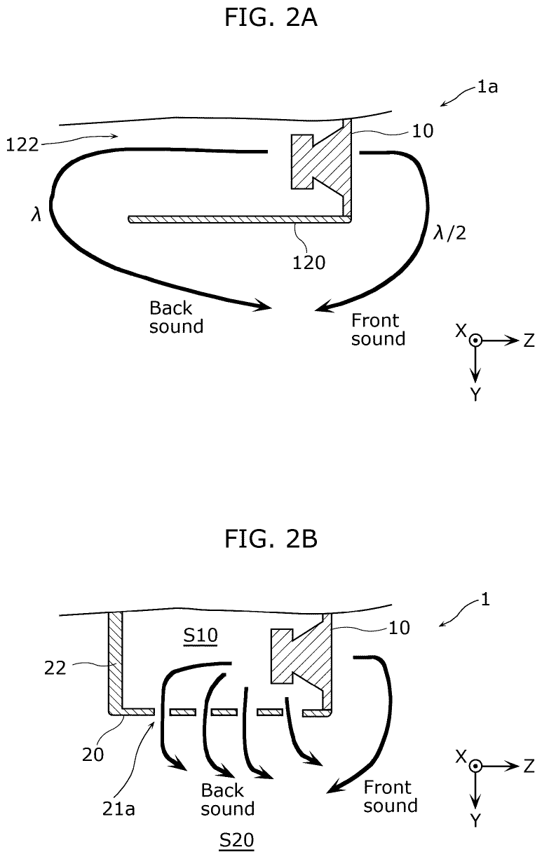

Casing 20 includes internal space S10 (see FIG. 2B for details) in which at least part of loudspeaker unit 10 (e.g., magnetic circuit 12) is housed. Casing 20 is also referred to as a loudspeaker cabinet or a loudspeaker box. For example, loudspeaker unit 10 is housed in casing 20 by being inserted into casing 20 from an opening on the Z-axis positive side of casing 20.

Casing 20 includes: tubular component 21 that is disposed on the lateral side of loudspeaker unit 10; base panel 22 that is disposed on the back side of loudspeaker unit 10 to face baffle board 23 in the Z-axis direction; and baffle board 23 that is disposed on the front side of loudspeaker unit 10. Internal space S10 is formed of tubular component 21, base panel 22, and baffle board 23.

Tubular component 21 is a component that is tubular and disposed between base panel 22 and baffle board 23. Baffle board 23 is provided to one (opening on the Z-axis positive side) of openings of tubular component 21, and base panel 22 is provided to the other (opening on the Z-axis negative side) of the openings of tubular component 21. Base panel 22 and baffle board 23 are provided to cover the openings of tubular component 21.

Tubular component 21 includes a plurality of through holes 21a (acoustic holes) that are located at different positions in a central axis direction of tubular component 21 and connect internal space S10 and external space S20 that is outside of casing 20. For example, the plurality of through holes 21a may be arranged in the central axis direction or in a zigzag pattern. Moreover, the plurality of through holes 21a may be spaced at equal intervals or different intervals in the central axis direction. It should be noted that the central axis direction is a direction that is parallel to the extending direction of tubular component 21 (that is also referred to as the cylindrical-axis direction or the Z-axis direction). Moreover, a plurality of columns that are each a column of the plurality of through holes 21a arranged in the central axis direction may be arranged in a circumferential direction of tubular component 21. The plurality of columns may be spaced at equal intervals in the circumferential direction.

It should be noted that the diameter of each of the plurality of through holes 21a and the volume of internal space S10 are set so that a sound in a high frequency range is not emitted from the plurality of through holes 21a by a high-cut filter effect achieved by the diameter of each of the plurality of through holes 21a and the volume of internal space S10. In other words, almost no sound in the high frequency range is emitted from through holes 21a. When sound absorbing component 40 is provided in internal space S10, a sound is attenuated by sound absorbing component 40. Therefore, emission of a sound in the high frequency range from through holes 21a can be further suppressed.

Base panel 22 is provided to cover the opening on the Z-axis negative side of tubular component 21. In other words, base panel 22 is disposed on a side (the Z-axis negative side) that is opposite to loudspeaker unit 10 in casing 20. Base panel 22 does not include a through hole that connects internal space S10 and external space S20 that is outside of casing 20.

Baffle board 23 includes opening 23a into which loudspeaker unit 10 is inserted to be attached to baffle board 23. Opening 23a is, for example, disposed at the center of baffle board 23; however, opening 23a may be disposed off-center of baffle board 23. Loudspeaker unit 10 is fixed at opening 23a of baffle board 23 in an orientation that exposes diaphragm 11 of loudspeaker unit 10. Baffle board 23 is an example of a fixing component.

Moreover, baffle board 23 may further include a plurality of through holes (not illustrated in the Drawings) that connect internal space S10 and external space S20 that is outside of casing 20. The number of through holes provided to baffle board 23 is not limited to two or more, and may be one.

It should be noted that although casing 20 is in a cylindrical shape in the embodiment, casing 20 may be in a rectangular parallelopiped shape, a spherical shape, an egg shape, or another three-dimensional shape. Moreover, tubular component 21 and at least one of base panel 22 or baffle board 23 may be integrally formed or configured to be attachable to or detachable from each other. A and B are attachable to or detachable from each other mean that one of A or B is attachable to or detachable from the other of A or B without damaging A and B. Moreover, casing 20 is made of, for example, metal, resin, wood, etc.

### (1-2. Directivity Characteristics of Sound Pressure of Loudspeaker Device)

The directivity y characteristics of sound pressure of loudspeaker device 1 configured as above will be described with reference to FIG. 2A to FIG. 4B. First, sounds reproduced by loudspeaker device 1 will be described with reference to FIG. 2A and FIG. 2B. FIG. 2A is a diagram for describing sounds reproduced in loudspeaker device 1a according to a comparative example. FIG. 2B is a diagram for describing sounds reproduced in loudspeaker device 1 according to the present embodiment.

As illustrated in FIG. 2A, loudspeaker device 1a according to the comparative example includes loudspeaker unit 10 and casing 120. Casing 120 does not include through hole 21a as well as base panel 22. It can be also said that loudspeaker device 1a includes an open-type loudspeaker box.

Sounds emitted from such a loudspeaker device 1a includes a front sound that is emitted forward from the front side of diaphragm 11 of loudspeaker unit 10 and a back sound that is emitted backward from the back side of diaphragm 11 through opening 122. The sounds emitted from the front side and the back side of diaphragm 11 are sounds having mutually inverted phases. However, there is concern that the phase of the front sound and the phase of the back sound are aligned with each other and thus sound pressure is increased around loudspeaker device 1a, depending on the distance traveled by the back sound within (the internal space of) casing 120. For example, there is concern that sound pressure of a sound in a middle frequency range is increased depending on the length of casing 120.

In contrast, in loudspeaker device 1 according to the present embodiment, tubular component 21 is provided with the plurality of through holes 21a that connect external space S20 and internal space S10 of casing 20. Therefore, a sound reproduced by loudspeaker unit 10 is canceled out by a sound that is emitted from at least one of the plurality of through holes 21a and has an inverted phase relative to the sound reproduced by loudspeaker unit 10. Specifically, as illustrated in FIG. 2B, sounds emitted from loudspeaker device 1 includes a front sound that is emitted forward from the front side of diaphragm 11 of loudspeaker unit 10 and back sounds that are emitted backward from the back side of diaphragm 11 through the plurality of through holes 21a. Since the front sound and at least one of the back sounds have mutually inverted phases, the front sound and the at least one of the back sounds are mutually canceled out.

Moreover, since the plurality of through holes 21a are spaced at predetermined intervals in the Z-axis direction, the phases of sounds emitted from through holes 21a are not aligned with each other. Therefore, even when the phase of the front sound and the phase of a sound emitted from one of the plurality of through holes 21a is aligned with each other, the phase of the front sound and the phase of each of sounds emitted from the rest of the plurality of through holes 21a are not aligned with each other. Therefore, an increase in sound pressure resulting from a front sound and a back sound overlapping each other is suppressed. For example, regardless of the length of casing 120, an increase in sound pressure of a sound in the middle frequency range is suppressed.

It should be noted that in the present Specification, a sound in the middle frequency range is a sound with a frequency between 800 Hz and 2000 Hz, inclusive, a sound in the low frequency range is a sound with a frequency lower than the middle frequency range (a sound with a frequency lower than 800 Hz), and a sound in the high frequency range is a sound with a frequency higher than the middle frequency range (a sound with a frequency higher than 2000 Hz). However, the present disclosure is not limited to this example.

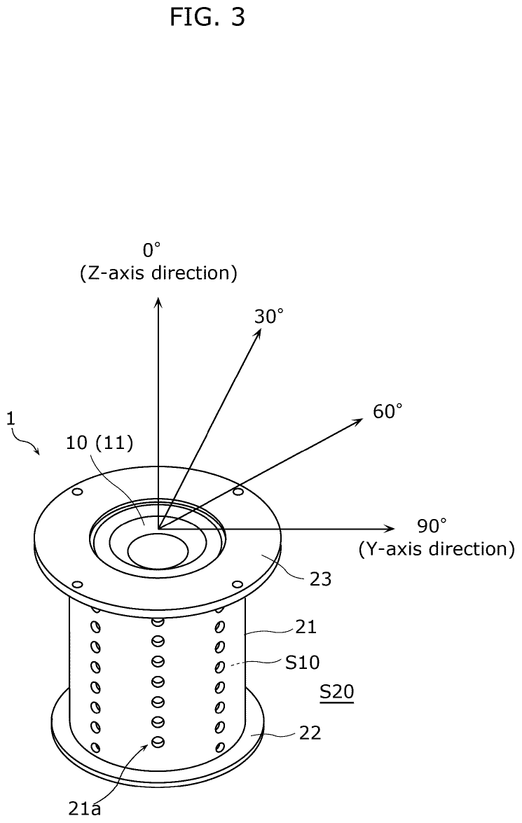

Next, each direction with respect to loudspeaker device 1 in evaluation of directivity is described with reference to FIG. 3. FIG. 3 is a diagram for describing each direction with respect to loudspeaker device 1.

As illustrated in FIG. 3, for evaluating directivity of loudspeaker device 1, sound pressure is evaluated for each of four directions that are a 0° direction, a 30° direction, a 60° direction, and a 90° direction. Each angle of the four directions is an angle with respect to a direction parallel to the Z-axis (the central axis direction), in other words, the 0° direction is a direction parallel to the Z-axis, the 30° direction is a direction at a 30° angle with respect to the Z-axis direction, the 60° direction is a direction at a 60° angle with respect to the Z-axis direction, and the 90° direction is a direction at a 90° angle with respect to the Z-axis direction. The 90° direction is, for example, a direction parallel to the Y-axis direction (or the X-axis direction).

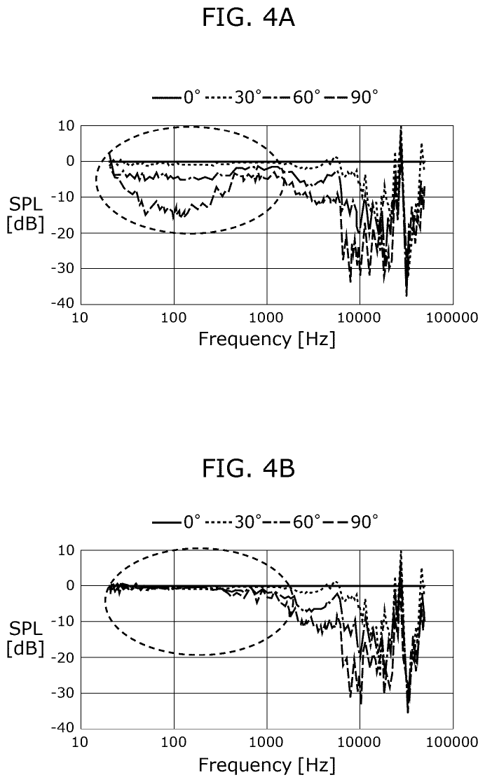

Next, the results of evaluation of the directivity characteristics of sound pressure of loudspeaker device 1 will be described with reference to FIG. 4A and FIG. 4B. FIG. 4A is a graph illustrating the directivity characteristics of sound pressure of loudspeaker device 1 according to the present embodiment. FIG. 4B is a graph illustrating the directivity characteristics of sound pressure of a loudspeaker device according to a conventional example. The loudspeaker device according to the conventional example is a loudspeaker device that is different from loudspeaker device 1 according to the present embodiment in that the loudspeaker device does not include through hole 21a.

In each of FIG. 4A and FIG. 4B, the horizontal axis indicates frequency and the vertical axis indicates sound pressure. Moreover, the graph illustrated in each of FIG. 4A and FIG. 4B shows results normalized by the sound pressure characteristics in the 0° direction. When sound pressure is lower than 0 dB, the sound pressure is lower than sound pressure in 0° direction, that is, in the front direction, and when sound pressure is higher than 0 dB, the sound pressure is higher than sound pressure in the front direction. It can be said that loudspeaker device 1 has directivity in the 0° direction when sound pressure in each of the 30°, 60°, and 90° directions is lower than 0 dB, and it can also be said that the directivity of loudspeaker device 1 becomes higher as sound pressure in each of the 30°, 60°, and 90° directions decreases.

As indicated by the broken line frame in FIG. 4A, the sound pressure in each of the 30°, 60°, and 90° directions of each of sounds with frequencies lower than or equal to approx. 1000 Hz is lower than or equal to 0 dB, and loudspeaker device 1 according to the present embodiment can achieve very narrow directivity particularly for sounds with frequencies lower than or equal to 400 Hz. It can also be said that loudspeaker device 1 has directivity in the front direction for a sound in the mid-low frequency range.

As indicated by the broken line frame in FIG. 4B, in the loudspeaker device according to the conventional example, the sound pressure in each of the 30°, 60°, and 90° directions of each of sounds with frequencies lower than or equal to approx. 1000 Hz is around 0 dB, and particularly the sound pressure of each of sounds with frequencies lower than or equal to 300 Hz is almost 0 dB. Accordingly, the loudspeaker device according to the conventional example cannot cancel out a sound that travels around the loudspeaker device, and has wide directivity for a sound in the mid-low frequency range. In other words, the loudspeaker device according to the conventional example does not have directivity in the front direction for a sound in the mid-low frequency range.

Thus, since loudspeaker device 1 can cancel out a sound (mainly a sound in the low frequency range) that travels around loudspeaker device 1 by utilizing the fact that a front sound and a back sound have mutually inverted phases, loudspeaker device 1 can achieve narrow directivity particularly for a sound in the low frequency range, without increasing the length of casing 20.

### Embodiment 2

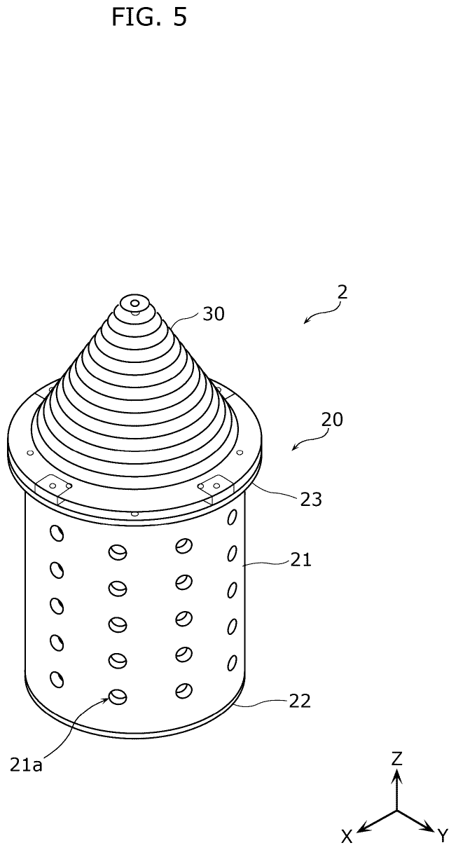

Hereinafter, a loudspeaker device according to the present embodiment will be described with reference to FIG. 5 to FIG. 10C. It should be noted that the description will be focused on the difference from Embodiment 1, and the content that is the same as or similar to Embodiment 1 will be omitted or simplified.

### (2-1. Configuration of Loudspeaker Device)

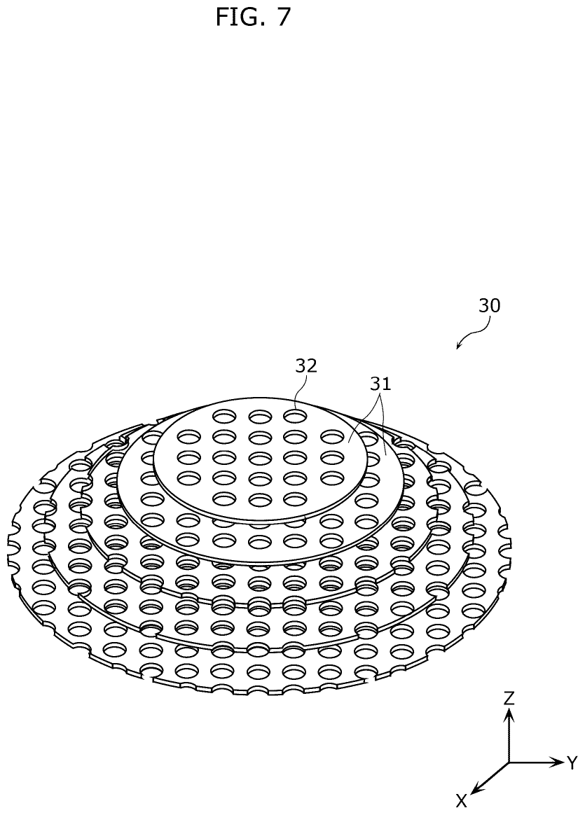

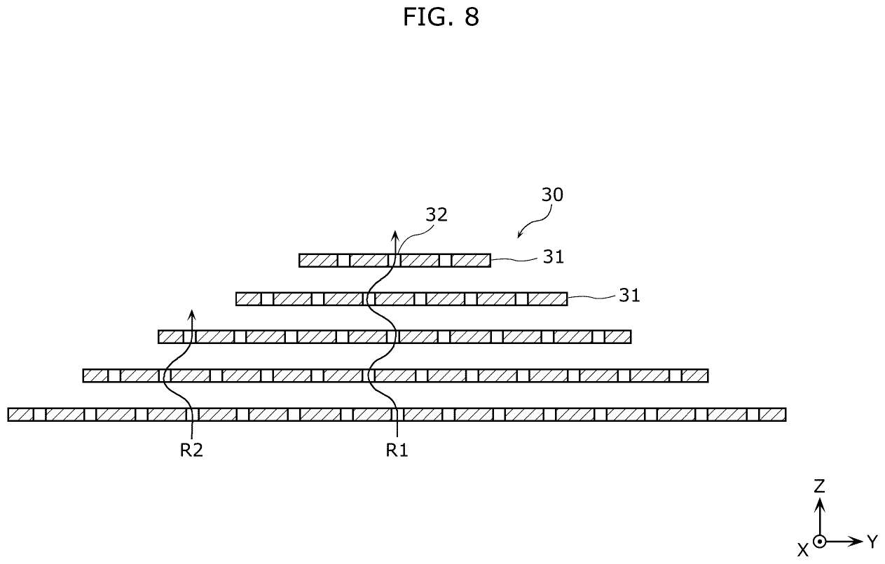

First, a configuration of the loudspeaker device according to the present embodiment will be described with reference to FIG. 5 to FIG. 9. FIG. 5 is a perspective view illustrating an example of the external appearance of loudspeaker device 2 according to the present embodiment. FIG. 6 is a cross-sectional perspective view illustrating an example of loudspeaker device 2 according to the present embodiment. FIG. 7 is a perspective view illustrating an example of the external appearance of acoustic lens 30 according to the present embodiment. FIG. 8 is a cross-sectional view of acoustic lens 30 according to the present embodiment.

Loudspeaker device 2 according to the present embodiment is different from loudspeaker device 1 according to Embodiment 1 in that loudspeaker device 2 includes acoustic lens 30 and sound absorbing component 40.

As illustrated in FIG. 5 and FIG. 6, loudspeaker device 2 includes acoustic lens 30 and sound absorbing component 40 in addition to the elements included in loudspeaker device 1 according to Embodiment 1. Since the configuration of loudspeaker device 2 other than acoustic lens 30 and sound absorbing component 40 is the same as that of loudspeaker device 1, the detailed description thereof is omitted.

Acoustic lens 30 is detachably disposed at a position that is outside of (i.e., in front of) diaphragm 11 of loudspeaker unit 10 in loudspeaker device 2 and at which acoustic lens 30 covers diaphragm 11. Acoustic lens 30 includes a plurality of plate-shaped components 31 (see FIG. 7 and FIG. 8) and a support component (not illustrated in the Drawings) that supports the plurality of plate-shaped components 31.

Each of the plurality of plate-shaped components 31 includes a plurality of through holes 32. The plurality of plate-shaped components 31 are arranged in descending order of external size toward the positive side (front side) in the Z-axis direction. In other words, among two adjacent plate-shaped components 31 out of the plurality of plate-shaped components 31, the external size of plate-shaped component 31 located on the Z-axis positive side is smaller than the external size of plate-shaped component 31 located on the Z-axis negative side. The two adjacent plate-shaped components 31 are arranged so that a plurality of through holes 32 of one of the two adjacent plate-shaped components 31 and a plurality of through holes 32 of the other of the two adjacent plate-shaped components 31 do not overlap with each other as viewed in the Z-axis direction.

The support component supports the plurality of plate-shaped components 31 in a state where the plurality of plate-shaped components 31 are spaced from each other. Moreover, the support component supports the plurality of plate-shaped components 31 in a state where, among the plurality of plate-shaped components 31, plate-shaped component 31 located most negative side in the Z-axis direction is spaced from baffle board 23. The support component is, for example, a columnar component that is elongated in the Z-axis direction.

Acoustic lens 30 is made of, for example, metal, resin, etc. The plurality of plate-shaped components 31 of acoustic lens 30 may be, for example, perforated metal plates of which diameters are different from each other.

With the above-described configuration, as illustrated in FIG. 8, acoustic lens 30 can cause a distance traveled by, among sounds emitted from loudspeaker unit 10, a sound that passes through first route R1 that is located in the vicinity of the central axis of loudspeaker unit 10 to be greater than a distance traveled by, among the sounds, a sound that passes through second route R2 that is located in the vicinity of (outside of) first route R1. Thus, a sound passing through the central axis of loudspeaker unit 10 is delayed in phase from a sound passing through a peripheral portion of loudspeaker unit 10 (a surrounding area of the central axis of loudspeaker unit 10). In other words, acoustic lens 30 includes: first route R1 that is located at a position that coincides with the central axis of loudspeaker unit 10; and second route R2 that is located in the vicinity of first route R1 and shorter than first route R1.

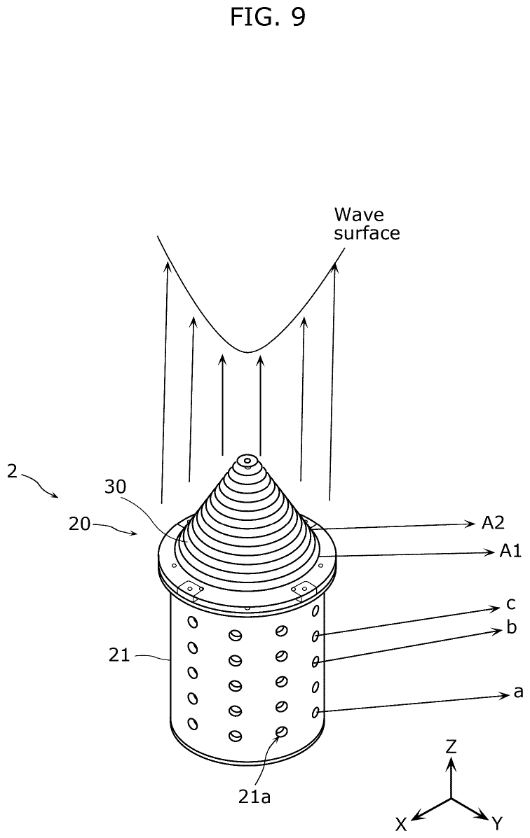

FIG. 9 is a diagram for describing an effect of acoustic lens 30 according to the present embodiment.

Although sounds in the high frequency range emitted from the front side of loudspeaker unit 10 are emitted through acoustic lens 30, since the outside diameter of acoustic lens 30 decreases in the traveling direction of the sounds, a traveling time during which, among the sounds, a sound emitted from a peripheral portion of loudspeaker unit 10 travels inside acoustic lens 30 is different from a traveling time during which, among the sounds, a sound emitted from a central portion of loudspeaker unit 10 travels inside acoustic lens 30. In other words, the traveling time of the sound emitted from the peripheral portion is short and the traveling time of the sound emitted from the central portion is long (see first route R1 and second route R2 in FIG. 8). As a result, a wave surface of the sounds emitted from acoustic lens 30 is formed in a recessed shape as illustrated in FIG. 9, and loudspeaker device 2 achieves narrow directivity so that sound pressure decreases from the central axis (acoustic axis) of loudspeaker device 2 toward the periphery of loudspeaker device 2. It should be noted that the acoustic axis indicates, for example, the output direction or the traveling direction of a sound outputted from loudspeaker device 2.

Moreover, regarding sounds in the low frequency range, sounds a, b, and c emitted from the back side of loudspeaker unit 10 are emitted through the plurality of through holes 21a of tubular component 21. At this time, since sounds A1 and A2 emitted from the front side of loudspeaker unit 10 through gaps between plate-shaped components 31 of acoustic lens 30 attached to loudspeaker unit 10 each have an inverted phase relative to the back sounds, cancellation of sound pressure occurs between the back sounds and the front sounds (e.g., between sounds a, b, and c and sounds A1 and A2). As a result, emission of a sound in the low frequency range in the lateral direction and the back direction from loudspeaker device 2 can be suppressed. In other words, even though loudspeaker device 2 is configured to include acoustic lens 30, loudspeaker device 2 has narrow directivity (in the front direction) particularly for a sound in the low frequency range, similar to Embodiment 1.

It should be noted that although an example in which acoustic lens 30 includes the plurality of plate-shaped components 31 each of which includes the plurality of through holes 32 has been described in the present embodiment, acoustic lens 30 is not limited to this configuration. Acoustic lens 30 may have any configuration as long as a distance traveled by, among sounds emitted from loudspeaker unit 10, a sound that passes through first route R1 that is located in the vicinity of the central axis of loudspeaker unit 10 is greater than a distance traveled by, among the sounds, a sound that passes through second route R2 that is located in the vicinity of first route R1. For example, acoustic lens 30 may be configured by stacking porous plates that have mutually different external shapes, and may be configured by stacking porous blocks so that the porous blocks are formed into a conical shape of which diameter decreases toward the top.

As illustrated in FIG. 6, sound absorbing component 40 is disposed in internal space S10. Sound absorbing component 40 is, for example, a cylindrical component. Since casing 20 includes base panel 22, a standing wave may be generated due to a back sound being reflected by base panel 22. Sound absorbing component 40 is provided to suppress generation of such a standing wave and absorbs part of a back sound.

### (2-2. Directivity Characteristics of Sound Pressure of Loudspeaker Device)

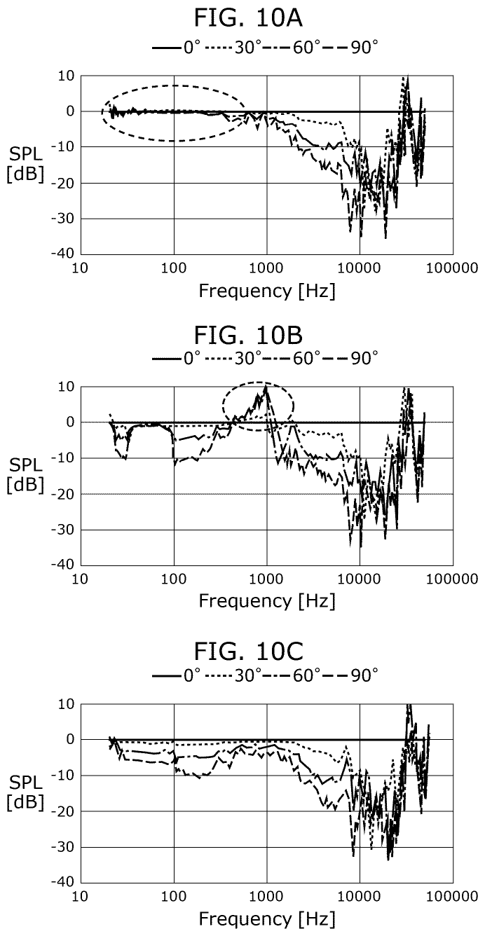

The directivity characteristics of sound pressure of loudspeaker device 2 configured as above will be described with reference to FIG. 10A to FIG. 10C. FIG. 10A is a graph illustrating the directivity characteristics of sound pressure of a loudspeaker device according to a conventional example. FIG. 10B is a graph illustrating the directivity characteristics of sound pressure of a loudspeaker device according to a comparative example. FIG. 10C is a graph illustrating the directivity characteristics of sound pressure of loudspeaker device 2 according to the present embodiment. Here, the loudspeaker device according to the conventional example has a configuration in which the plurality of through holes 21a in loudspeaker device 2 according to the present embodiment are not included, and the loudspeaker device according to the comparative example has a configuration in which the plurality of through holes 21a and base panel 22 in loudspeaker device 2 according to the present embodiment are not included.

As indicated by the broken line frame in FIG. 10A, in the loudspeaker device according to the conventional example, the sound pressure in each of the 30°, 60°, and 90° directions of each of sounds with frequencies lower than or equal to approx. 1 kHz is around 0 dB, and particularly the sound pressure of each of sounds with frequencies lower than or equal to 300 Hz is almost 0 dB. Accordingly, the loudspeaker device according to the conventional example cannot cancel out a sound that travels around the loudspeaker device, and does not have directivity for a sound in the mid-low frequency range.

As indicated by the broken line frame in FIG. 10B, in the loudspeaker device according to the comparative example, the sound pressure in each of the 30°, 60°, and 90° directions of each of sounds with mid-range frequencies around approx. 1 kHz is greater than 0 dB. This is because the phase of the front sound and the phase of the back sound have been aligned with each other and the sound pressure has been increased in each direction. Thus, the loudspeaker device according to the comparative example has wide directivity for a sound in the middle frequency range, for example.

As indicated by the broken line frame in FIG. 10C, the sound pressure in each of the 30°, 60°, and 90° directions of each of sounds with frequencies lower than or equal to approx. 1 kHz is lower than or equal to 0 dB, and loudspeaker device 2 according to the present embodiment can achieve narrow directivity particularly for sounds with frequencies lower than or equal to 400 Hz. Moreover, it can be seen that the sound pressure is unlikely to increase and is not greater than 0 dB in the middle frequency range around 1 kHz as well, in contrast to FIG. 10B. Thus, loudspeaker device 2 has narrow directivity for a sound in the mid-low frequency range.

Accordingly, the directivity of a sound that is in a range from the low frequency range to the high frequency range and is emitted from loudspeaker unit 10 is narrow in the front direction, and it is possible to reduce sound leakage to the surroundings. In particular, acoustic lens 30 can control a sound in the high frequency range to have directivity in the front direction. Therefore, loudspeaker device 2 according to the present embodiment can control not only the directivity of a sound in the low frequency range but also the directivity of a sound in the high frequency range.

### Embodiment 3

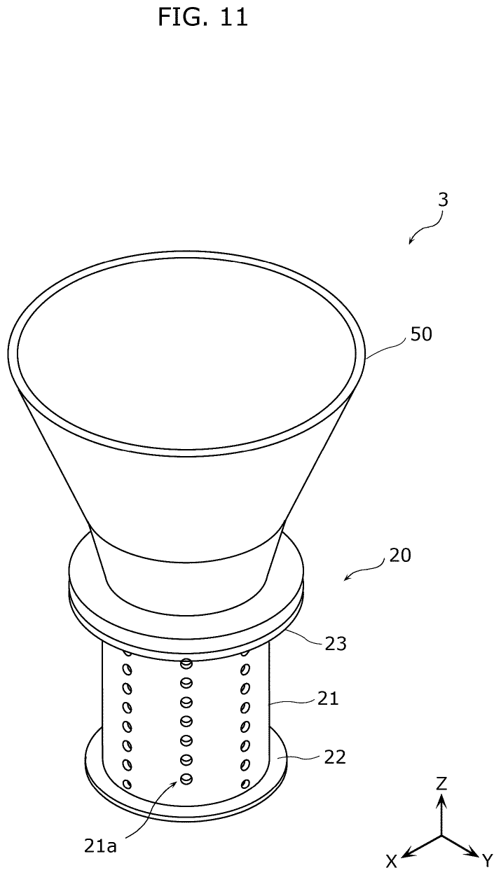

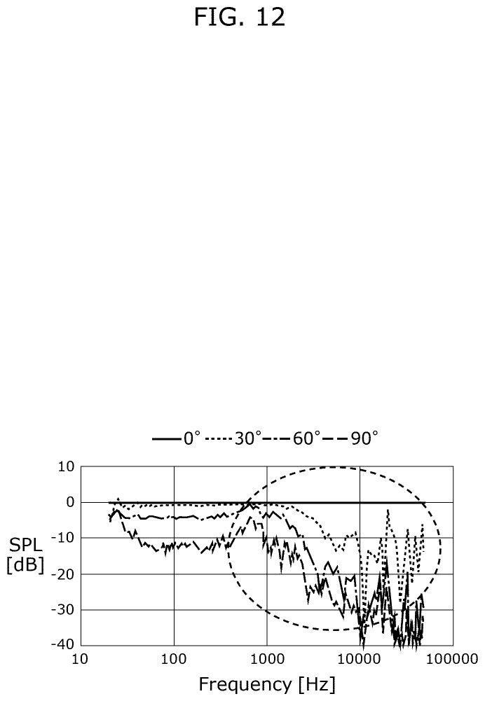

Hereinafter, a loudspeaker device according to the present embodiment will be described with reference to FIG. 11 and FIG. 12. It should be noted that the description will be focused on the difference from Embodiment 1, and the content that is the same as or similar to Embodiment 1 will be omitted or simplified.

### (3-1. Configuration of Loudspeaker Device)

First, a configuration of the loudspeaker device according to the present embodiment will be described with reference to FIG. 11. FIG. 11 is a perspective view illustrating an example of the external appearance of loudspeaker device 3 according to the present embodiment.

Loudspeaker device 3 according to the present embodiment is different from loudspeaker device 1 according to Embodiment 1 in that loudspeaker device 3 includes horn 50.

As illustrated in FIG. 11, loudspeaker device 3 includes horn 50 in addition to the elements included in loudspeaker device 1 according to Embodiment 1. Since the configuration of loudspeaker device 3 other than horn 50 is the same as that of loudspeaker device 1, the detailed description thereof is omitted. It should be noted that loudspeaker device 3 may further include a sound absorbing component (e.g., sound absorbing component 40 shown in FIG. 6) in casing 20.

Horn 50 is cylindrical, is opened in the front-back direction (Z-axis direction), and is detachably attached to baffle board 23 of casing 20 to surround a space in front of loudspeaker unit 10. Horn 50 is disposed outside of (i.e., in front of) diaphragm 11 of loudspeaker unit 10 in loudspeaker device 3, and an opening on the baffle board 23 side of horn 50 is larger than diaphragm 11 in a plan view. Horn 50 includes an internal surface that gradually widens toward the front. A sound outputted from loudspeaker unit 10 is emitted to external space S20 through horn 50.

### (3-2. Directivity Characteristics of Sound Pressure of Loudspeaker Device)

The directivity characteristics of sound pressure of loudspeaker device 3 configured as above will be described with reference to FIG. 12. FIG. 12 is a graph illustrating the directivity characteristics of sound pressure of loudspeaker device 3 according to the present embodiment.

As illustrated in FIG. 12, loudspeaker device 3 has narrow directivity for a sound in the mid-high frequency range by a horn effect since loudspeaker device 3 includes horn 50. The sound pressure in each of the 30°, 60°, and 90° directions of each of sounds with frequencies greater than or equal to approx. 1 kHz is lower than or equal to 0 dB, and loudspeaker device 3 can achieve very narrow directivity particularly for sounds with frequencies around 10 KHz.

Moreover, the sound pressure of each of sounds in the low frequency range is also lower than 0 dB, and it can be seen that a sound that is emitted from horn 50 and travels around loudspeaker device 3 can be canceled out by a sound emitted from at least one of through holes 21a.

Thus, loudspeaker device 3 is configured to have narrow directivity for a sound in the low frequency range by through holes 21a of casing 20 and have narrow directivity for a sound in the mid-low frequency range by horn 50. Accordingly, loudspeaker device 3 that has directivity in the front direction for a sound in a wide range from the low frequency range to the high frequency range can be realized.

### OTHER EMBODIMENTS

Although a loudspeaker device according to one or more aspects has been described based on the embodiments, the present disclosure is not limited to the embodiments. Forms obtained by various modifications to respective embodiments that can be conceived by a person skilled in the art as well as forms realized by combining constituent elements in different embodiments may be included in the scope of the present disclosure as long as they do not depart from the essence of the present disclosure.

For example, although an example in which the number of the plurality of through holes 21a provided to tubular component 21 is two or more has been described in each of the above-described embodiments, the number of the plurality of through holes 21a is not limited to two or more and may be one. For example, a sound emitted from a single through hole 21a has an inverted phase relative to a sound emitted directly to external space S20 from diaphragm 11.

Moreover, although an example in which each of the plurality of through holes 21a is a cylindrical hole has been described in each of the above-described embodiments, the present disclosure is not limited to this example and each of the plurality of through holes 21a may be a rectangular columnar hole or an elliptical cylindrical hole, for example. The shape of each of the plurality of through holes 21a is not particularly limited as long as a sound that has an inverted phase relative to a sound emitted directly to external space S20 from diaphragm 11 can be emitted through at least one of the plurality of through holes 21a.

### INDUSTRIAL APPLICABILITY

The present disclosure is useful as a loudspeaker device or the like that has narrow directivity.

1. A loudspeaker device comprising:
a loudspeaker unit; and
a casing that defines an internal space in which the loudspeaker unit is housed, wherein
the casing includes:
a fixing component that fixes the loudspeaker unit in an orientation that exposes a diaphragm of the loudspeaker unit;
a tubular component that includes, at one end, an opening to which the fixing component is provided and, at an other end, an other opening; and
a base panel that covers the other opening of the tubular component, and
the tubular component further includes a plurality of through holes that connect the internal space and an external space that is outside of the casing, the plurality of through holes being located at different positions in a central axis direction of the tubular component.

2. The loudspeaker device according to claim 1, wherein
the plurality of through holes are arranged in the central axis direction.

3. The loudspeaker device according to claim 2, wherein
a plurality of columns that are each a column of the plurality of through holes arranged in the central axis direction are arranged in a circumferential direction of the tubular component.

4. The loudspeaker device according to claim 1, further comprising:
a sound absorbing component that is disposed in the internal space.

5. The loudspeaker device according to claim 1, further comprising:
an acoustic lens that is disposed at a position that is outside of the diaphragm of the loudspeaker unit and at which the acoustic lens covers the diaphragm.

6. The loudspeaker device according to claim 5, wherein
the acoustic lens includes:
a first route that is located at a position that coincides with a central axis of the loudspeaker unit; and
a second route that is located in a vicinity of the first route and is shorter than the first route.

7. The loudspeaker device according to claim 1, further comprising:
a horn that is disposed outside of the diaphragm of the loudspeaker unit and emits a sound outputted from the loudspeaker unit.
